(19) United States
(12) Patent Application Publication
(10) Pub. No.: US 2007/0096934 A1
(43) Pub. Date: May 3, 2007

(54) GUIDE LIGHTING DEVICE

(76) Inventor: SANG-JIN MOON, Seoul (KR)

Correspondence Address: IPLA P.A., 3580 WILSHIRE BLVD., 17TH FLOOR, LOS ANGELES, CA, 90010, US

(21) Appl. No.: 11/307,898

(22) Filed: Feb. 27, 2006

(30) Foreign Application Priority Data
Nov. 2, 2005 (KR) 10-2005-0104388

(51) Int. Cl. G08B 3/00; G08B 17/00; G08B 1/00

(52) U.S. Cl. 340/691.1; 340/584; 340/531

(57) ABSTRACT

Disclosed herein is a guide lighting device. The guide lighting device of the present invention of the present invention includes a power supply unit, a sensing unit, an output unit, an input unit and a guide lamp control unit. The present invention provides a guide lighting device, which uses a remote controller to more easily examine whether auxiliary power is normally supplied, and sets an examination time, thus improving convenience in the use of the guide lighting device.

### BACKGROUND OF THE INVENTION

1. Field of the Invention

The present invention relates, in general, to guide lighting devices and, more particularly, to a guide lighting device, which is installed in a building to guide persons to an emergency exit when an emergency, such as a fire or power failure, occurs.

2. Description of the Related Art

Generally, a guide lighting device is required to help persons escape from an emergency situation when an emergency, such as a fire or power failure, occurs. At normal times, commercial power is supplied to the guide lighting device to be lit, or power is supplied only to a battery charging circuit while the guide lighting device is not lit, in order to charge auxiliary power. When commercial AC power is interrupted in an emergency, the guide lighting device is lit for a certain period of time using the auxiliary power, thus functioning to notify persons of the location of an emergency exit. Therefore, the conventional guide lighting device is provided with a pull switch or limit switch to determine whether auxiliary power of the guide lighting device is normally charged. Accordingly, if the pull switch is pressed or the rope thereof is drawn, the switch is opened so as to interrupt AC power, so that whether auxiliary power is normally supplied can be determined and examined.

However, if the guide lighting device is installed at a high location, such as the ceiling, the pull switch or limit switch cannot be manipulated, and a tool, such as a ladder, must be used to carry out an examination. Accordingly, such an examination method makes it very inconvenient for an examiner to determine whether auxiliary power is normally supplied. Therefore, the examiner frequently leaves the guide lighting device in its existing state without examining it, so that the guide lighting device does not operate normally in an emergency. As a result, there is a limitation in that evacuating persons cannot be guided to an emergency exit in a short period of time, and it is impossible to prevent the loss of lives from occurring.

### SUMMARY OF THE INVENTION

Accordingly, the present invention has been made keeping in mind the above problems occurring in the prior art, and an object of the present invention is to provide a guide lighting device, which enables easy examination of whether the auxiliary power of the guide lighting device is normally supplied.

Another object of the present invention is to provide a guide lighting device, which has improved functionality for rescuing evacuating persons.

Other objects and advantages of the present invention will be more clearly described and understood from the embodiments of the present invention. The objects and advantages of the present invention can be realized by means and combination disclosed in the accompanying claims.

In order to accomplish the above objects, the present invention provides a guide lighting device, comprising a power supply unit for supplying main power and auxiliary power; a sensing unit for sensing occurrence of an emergency at a location where the guide lighting device is installed, using temperature and illuminance; an output unit including a display window for lighting a lamp provided therein in response to a signal output from the sensing unit, thus indicating a location of an emergency exit; an input unit including a remote controller for receiving a command required to interrupt supply of the main power and to examine status of supply of the auxiliary power; and a guide lamp control unit for controlling operation of the power supply unit, the sensing unit, the output unit and the input unit.

Preferably, the remote controller may have a function of setting an examination time.

Preferably, the output unit may further comprise a radio transmitter for outputting a radio broadcast at a preset frequency through a speaker when an emergency occurs.

Preferably, the guide lamp control unit may transmit information indicating occurrence of an emergency to a center control unit for managing and controlling an entire building, and the input unit may further comprise a rescue button for transmitting a rescue signal to the center control unit through the guide lamp control unit when an emergency occurs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a guide lighting device according to an embodiment of the present invention; and

FIG. 2 is a block diagram schematically showing the guide lighting device of FIG. 1.

### DESCRIPTION OF THE PREFERRED EMBODIMENTS

Hereinafter, embodiments of the present invention will be described in detail with reference to the attached drawings. Prior to the description thereof, the terms and words used in the present specification and claims should not be interpreted as being limited to their typical meaning based on the dictionary definitions thereof, but should be interpreted to have the meaning and concept relevant to the technical spirit of the present invention, based on the fundamental notion that the present inventor can suitably define the concept of the terms to describe the invention using the best method.

Therefore, the constructions in the embodiments described in the present specification and in the drawings are only preferred embodiments of the present invention, and do not define the entire technical spirit of the present invention. Therefore, those skilled in the art will understand that various equivalents and modifications capable of replacing the constructions at the time of filing the present invention.

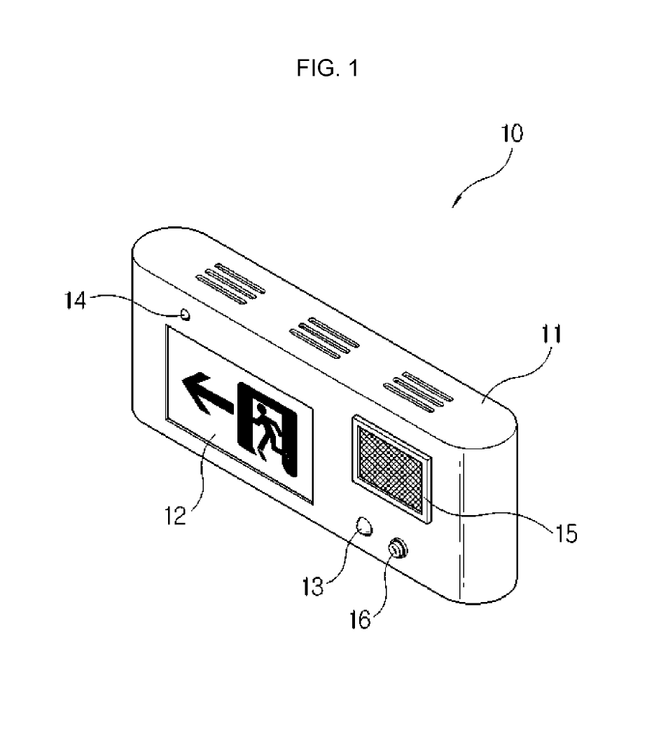

FIG. 1 is a perspective view of a guide lighting device according to an embodiment of the present invention. As shown in FIG. 1, the guide lighting device according to a preferred embodiment of the present invention includes a casing 11 that has a rear surface supportable on a wall and is made of a metallic material. Further, in the casing 11, a display window 12, a fire sensor 13, a Light Emitting Diode (LED) 14 for indicating whether power is supplied, a speaker 15 for outputting radio broadcasts, and a rescue button 16 are provided.

In this case, the display window 12 includes therein a lamp lit by power and functions to indicate the location of an emergency exit using a simple image or symbol. Preferably, the external surface of the display window 12 is covered with a heat-resistant glass cover to protect it from fire, etc.

The present invention can be described in that, for the fire sensor 13, a temperature sensing unit for sensing heat and an illuminance sensing unit for sensing light are used. Further, a smoke sensing unit for sensing smoke can also be used for the fire sensor 13.

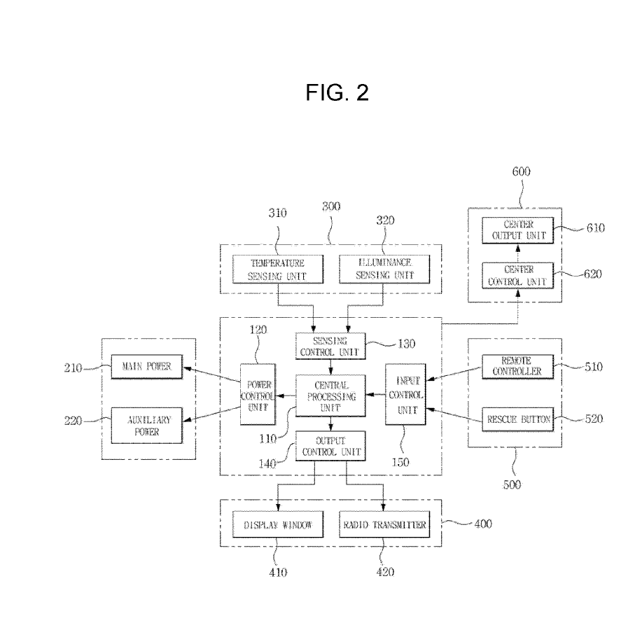

FIG. 2 is a block diagram schematically showing the guide lighting device of FIG. 1. As shown in FIG. 1, the guide lighting device of the present invention includes a power supply unit 200 for supplying main power 210 and auxiliary power 220, a sensing unit 300 for sensing the occurrence of an emergency at the location where the guide lighting device is installed, using temperature and illuminance, an output unit 400 including a display window 410 for lighting a lamp provided therein in response to a signal output from the sensing unit 300, thus indicating the location of an emergency exit, an input unit 500 including a remote controller 510 for receiving a command required to interrupt the supply of the main power 210 and to examine the status of the supply of auxiliary power 220, and a guide lamp control unit 100 for controlling the operation of the power supply unit 200, the sensing unit 300, the output unit 400 and the input unit 500.

The main power 210 of the power supply unit 200 is used to supply power under normal conditions and the auxiliary power 220 is used to ensure the continuous supply of power even when the supply of the main power 210 is interrupted in an emergency.

The sensing unit 300 is provided with a temperature sensing unit 310 and an illuminance sensing unit 320 to sense the temperature and illuminance of the place where the guide lighting device is installed, thus allowing the guide lamp control unit 100 to determine whether an emergency occurs.

The output unit 400 further includes a radio transmitter 420 for outputting a radio broadcast at a preset frequency through a speaker 15 while lighting the display window 410 if an emergency occurs. A person, evacuating in the event of an emergency, can understand the external situation by listening to the radio broadcast from the radio transmitter 420, remain calm, and then try to find an escape route for himself or herself when the person is isolated in a building or a similar space.

The remote controller 510 of the input unit 500 can simultaneously examine a plurality of guide lamps using the same frequency through a single manipulation. Further, the remote controller 510 has the function of setting an examination time and can be used as a typical watch when the remote controller 510 is not used.

Further, the guide lamp control unit 100 transmits information indicating the occurrence of an emergency, etc. to a center control unit 610 for managing and controlling an entire building. The input unit 500 further includes a rescue button 520 which transmits a rescue signal to the center control unit 610 through the guide lamp control unit 100 when an emergency occurs. Therefore, an evacuating person can press the rescue button 520 to notify outside parties of his or her location when the person is isolated, and can be quickly rescued from the emergency. In this case, the center control unit 610 is installed in a center management unit 600 for managing the entire building. The center management unit 600 includes a center output unit 620 capable of outputting information transmitted from the guide lamp control unit 100, thus detecting the location of an evacuating person in the building.

The guide lamp control unit 100 also includes a central processing unit 110, and further, a power control unit 120, a sensing control unit 130, an output control unit 140 and an input control unit 150 for controlling the power supply unit 200, the sensing unit 300, the output unit 400 and the input unit 500, respectively.

As described above, the present invention provides a guide lighting device, which uses a remote controller to more easily examine whether auxiliary power is normally supplied, and sets an examination time, thus improving convenience in the use of the guide lighting device.

Further, the present invention is advantageous in that when an emergency occurs, an external situation can be understood through radio broadcasts, and information about the location of an evacuating person can be externally provided using a rescue button, thus improving a rescue function.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A guide lighting device, comprising:
a power supply unit for supplying main power and auxiliary power;
a sensing unit for sensing occurrence of an emergency at a location where the guide lighting device is installed, using temperature and illuminance;
an output unit including a display window for lighting a lamp provided therein in response to a signal output from the sensing unit, thus indicating a location of an emergency exit;
an input unit including a remote controller for receiving a command required to interrupt supply of the main power and to examine status of supply of the auxiliary power; and
a guide lamp control unit for controlling operation of the power supply unit, the sensing unit, the output unit and the input unit.

2. The guide lighting device according to claim 1, wherein the remote controller has a function of setting an examination time.

3. The guide lighting device according to claim 1, wherein the output unit further comprises a radio transmitter for outputting a radio broadcast at a preset frequency through a speaker when an emergency occurs.

4. The guide lighting device according to claim 1, wherein:
the guide lamp control unit transmits information indicating occurrence of an emergency to a center control unit for managing and controlling an entire building, and the input unit further comprises a rescue button for transmitting a rescue signal to the center control unit through the guide lamp control unit when an emergency occurs.
